(19) United States
(12) Patent Application Publication
(10) Pub. No.: US 2009/0147533 A1
(43) Pub. Date: Jun. 11, 2009

(54) Display Device

(76) Inventors: Kee Tae Um, Gunpo-si (KR); Kyu Tae Lee, Seoul (KR)

Correspondence Address: SALIWANCHIK LLOYD & SALIWANCHIK;A PROFESSIONAL ASSOCIATION, PO Box 142950, GAINESVILLE, FL, 32614, US

(21) Appl. No.: 12/330,022

(22) Filed: Dec. 8, 2008

(30) Foreign Application Priority Data
Dec. 6, 2007 (KR) 10-2007-0125921

(51) Int. Cl. F21V 8/00; F21V 5/00

(52) U.S. Cl. 362/608; 362/613

(57) ABSTRACT

A display device is provided. The display device comprises a light guide plate; a first light source being disposed at a side of the light guide plate and having a first half-power angle; a second light source being disposed at the side of the light guide plate and having a second half-power angle; and a display panel on the light guide plate.

### CROSS-REFERENCE TO RELATED APPLICATION

The present application claims the benefit under 35 U.S.C. §119 to Korean Patent Application No. 10-2007-0125921, filed Dec. 6, 2007, which is hereby incorporated by reference in its entirety.

### BACKGROUND

The present disclosure relates to a display device.

With the development of the information-oriented society, there are increasing demands for various display devices. Currently, various flat display devices such as liquid crystal displays (LCDs) and plasma display panels (PDPs) are used.

However, large and slim flat display devices have low brightness uniformity.

### BRIEF SUMMARY

Embodiments provide a slim display device having improved brightness uniformity.

In an embodiment, a display device comprises: a light guide plate; a first light source being disposed at a side of the light guide plate and having a first half-power angle; a second light source being disposed at the side of the light guide plate and having a second half-power angle; and a display panel on the light guide plate.

In an embodiment, a display device comprises: a light guide plate; first and second light sources at a side of the light guide plate; a half-power angle adjustment member between the light guide plate and the first light source; and a display panel on the light guide plate.

In an embodiment, a display device comprises: a light guide plate; a plurality of first light sources at a side of the light guide plate; a plurality of second light sources disposed at the side of the light guide plate and having an angular light distribution distinguished from that of the first light source; and a display panel on the light guide plate.

Since the liquid crystal displays of the embodiments comprise first and second light sources having different half-power angles, light emitted from the first and second light sources can be uniformly cast into close and distant regions of the light guide plate.

Therefore, according to the embodiments, the liquid crystal display can have improved brightness uniformity.

Furthermore, according to the embodiments, the liquid crystal display can have a large screen using the light guide plate.

The details of one or more embodiments are set forth in the accompanying drawings and the description below. Other features will be apparent from the description and drawings, and from the claims.

### BRIEF DESCRIPTION OF THE DRAWINGS

FIG. 1 is an exploded perspective view illustrating a liquid crystal display according to an embodiment.

FIG. 2 is a plan view illustrating a light guide plate, first light sources, and a light emitting source substrate according to an embodiment.

FIG. 3 is a cross-sectional view illustrating the liquid crystal display according to an embodiment.

FIG. 4 is a cross-sectional view illustrating a liquid crystal display according to another embodiment.

FIG. 5 is a plan view illustrating a light guide plate, first light sources, second light sources, and a light emitting source substrate according to an embodiment.

FIG. 6 is a cross-sectional view illustrating a liquid crystal display according to another embodiment.

FIG. 7 is a cross-sectional view illustrating a liquid crystal display according to another embodiment.

FIG. 8 is a cross-sectional view illustrating a liquid crystal display according to another embodiment.

### DETAILED DESCRIPTION

In the following description, it will be understood that when a part such as a panel, a member, a frame, a sheet, a tape, and a substrate is referred to as being ‘on’ another part, it can be directly on the another part, or intervening parts may also be present. Further, it will be understood that when a part is referred to as being ‘under’ another part, it can be directly under the another layer, or one or more intervening layers may also be present. In addition, it will also be understood that when a part is referred to as being ‘between’ two parts, it can be the only part between the two parts, or one or more intervening parts may also be present. Spatially relative terms, such as “upper” and “lower” are used herein for ease of description to describe one element or feature's relationship to another element(s) or feature(s) as illustrated in the figures. In the drawings, the sizes of elements are exaggerated for clarity.

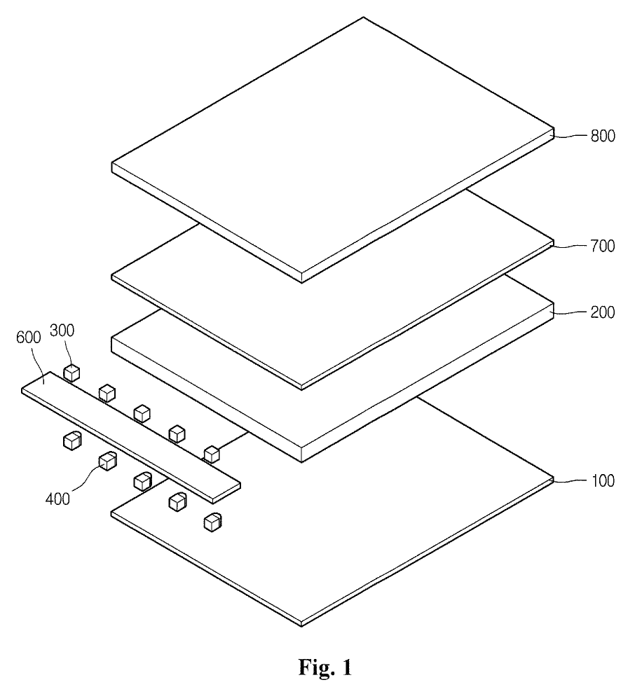

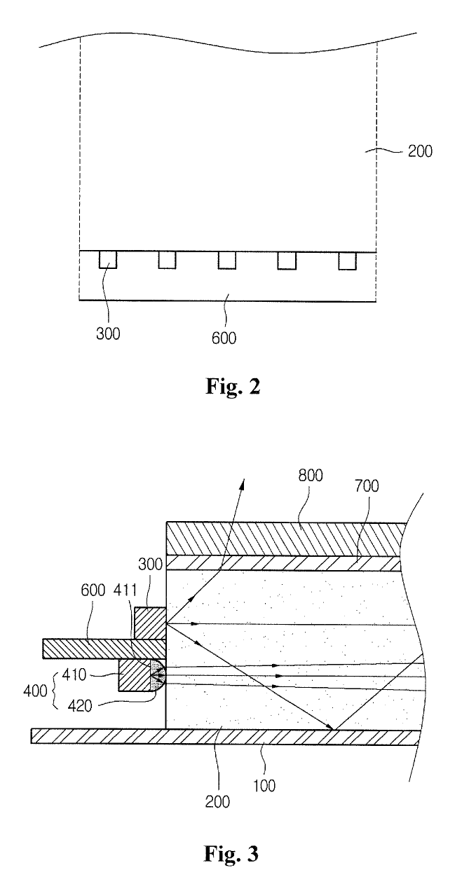

FIG. 1 is an exploded perspective view illustrating a liquid crystal display according to an embodiment; FIG. 2 is a plan view illustrating a light guide plate, first light sources, and a light emitting source substrate according to an embodiment; and FIG. 3 is a cross-sectional view illustrating the liquid crystal display according to an embodiment.

Referring to FIGS. 1 to 3, the liquid crystal display includes a reflective plate 100, a light guide plate 200, first light sources 300, second light sources 400, a light emitting source substrate 600, an optical sheet 700, and a liquid crystal panel 800.

The reflective plate 100 reflects light generated by the first and second light sources 300 and 400 in an upward direction. The reflective plate 100 has a plate or sheet shape.

The light guide plate 200 is disposed above the reflective plate 100. While light generated from the first and second light sources 300 and 400 passes through the light guide plate 200, the light is scattered, refracted, and reflected, and then the light is output upward from the light guide plate 200. For example, the light guide plate 200 may have a plate shape. The light guide plate 200 may be formed of a material such as poly methyl methacrylate (PMMA), polystyrene (PS), and Polycarbonate (PC).

The first light sources 300 are disposed at a side of the light guide plate 200. In detail, the first light sources 300 are arranged in a row along the side of the light guide plate 200, and the first light sources 300 emit light toward the light guide plate 200.

For example, the first light sources 300 may be light emitting diodes (LEDs) including red, green, and blue LEDs.

For example, red, green, and blue LEDs may be alternately arranged.

Alternatively, the first light sources 300 may be cold cathode fluorescent lamps or external electrode fluorescent lamps.

The second light sources 400 are disposed at the side of the light guide plate 200. The second light sources 400 are arranged in a row under the first light sources 300.

The second light sources 400 have a half-power angle different from that of the first light sources 300. That is, an angular light distribution of the second light sources 400 is distinguished with that of the first light sources. The angular light distribution means the intensity distribution of the light emitted by the first light sources 300 and the second light sources 400 with respected to the angle.

In more detail, the second light sources 400 have a half-power angle smaller than that of the first light sources 300. In other words, when an angle between two points where optical power is half the maximum optical power is considered, the angle of the second light sources 400 is smaller than that of the first light sources 300. The second light sources 400 may have output power greater than that of the first light sources 300.

That is, the second light sources 400 emit light condensed more than light emitted by the first light sources 300. Therefore, the second light sources 400 can emit light that is more intensive and goes farther than light emitted by the first light sources 300.

Each of the second light sources 400 includes a first light emitting unit 410 and a first lens 420.

The first light emitting unit 410 generates light and includes a light emitting surface 411. The first light emitting unit 410 emits light toward the first lens 420. In other words, the first light emitting unit 410 emits lights toward the light guide plate 200.

For example, the first light emitting unit 410 may be an LED. The first light emitting unit 410 may be a red, green, or blue LED.

Alternatively, the first light emitting unit 410 may be a white LED emitting white light.

The first lens 420 is disposed on the light emitting surface 411. For example, the first lens 420 may be disposed between the first light emitting unit 410 and the light guide plate 200. Light emitted by the first light emitting unit 410 is condensed by the first lens 420.

In more detail, the first lens 420 condenses light emitted from the first light emitting unit 410. For example, the first lens 420 condenses light emitted from the first light emitting unit 410 so that the light is parallel with the light guide plate 200.

The first lens 420 may be a convex lens or a Fresnel lens.

For example, a convex lens having convex surfaces on its both sides may be used as the first lens 420, or a convex lens having a flat surface on one side and a convex surface on the other side may be used as the first lens 420. In the latter case, the flat surface of the convex lens may face the first light emitting unit 410 or the light guide plate 200.

In the case where the first lens 420 is a Fresnel lens, the Fresnel lens may have a substantially flat front surface and a convex rear surface, and the substantially flat front surface may be formed by arranging a plurality of ring-shaped prisms having different sizes. The substantially flat surface may face the first light emitting unit 410 or the light guide plate 200.

Owing to the first lens 420, light emitted from the first light emitting unit 410 can be condensed to a desired degree (hereinafter, referred to as a condensing degree). Light emitted from the first light emitting unit 410 can be condensed to a proper condensing degree according to the size of the light guide plate 200 by using the first lens 420. For example, when the light guide plate 200 has a large surface area, light may be condensed to a high condensing degree.

On the other hand, when the light guide plate 200 has a small surface area, light may be condensed to a low condensing degree.

For example, the condensing degree of light may be adjusted by changing the radius of curvature or focus length of the first lens 420.

According to the first lens 420, the half-power angle of the second light source 400 is adjusted. That is, the first lens 420 is a half-power angle adjustment member of the second light source 400.

The light emitting source substrate 600 is disposed between the first light sources 300 and the second light sources 400. The light emitting source substrate 600 is electrically connected to the first and second light sources 300 and 400 for driving the first and second light sources 300 and 400.

The light emitting source substrate 600 is formed of a material having high heat conductivity. That is, the light emitting source substrate 600 also functions as a heat dissipating member that absorbs heat generated from the first and second light sources 300 and 400 and dissipates the heat to the outside area.

The light emitting source substrate 600 is a metal printed circuit board (MPCB).

The number of the first light sources 300 may be different from the number of the second light sources 400. For example, the number of the first light sources 300 may be smaller than the number of the second light sources 400. The numbers of the first and second light sources 300 and 400 may be determined by the size and desired brightness of the liquid crystal display.

The optical sheet 700 is disposed on the light guide plate 200. The optical sheet 700 improves the characteristics of light passing through the optical sheet 700. For example, the optical sheet 700 may include a diffusion sheet, a prism sheet, and a polarization sheet.

The liquid crystal panel 800 is disposed on the optical sheet 700. The liquid crystal panel 800 displays images by controlling the intensity of light passing therethrough according to pixels (image display basic units). For example, the liquid crystal panel 800 may include a thin film transistor (TFT) substrate, a color filter substrate, and a liquid crystal layer disposed between the TFT substrate and the color filter substrate.

Light emitted from the first light sources 300 toward the light guide plate 200 is diffused more than light emitted from the second light sources 400. Therefore, light emitted from the first light sources 300 travels a relatively short distance from the first light sources 300 and the second light sources 400.

On the other hand, light emitted from the second light sources 400 has a half-power angle smaller than that of light emitted from the first light sources 300. Therefore, light emitted from the second light sources 400 travels a relatively long distance from the first light sources 300 and the second light sources 400.

Therefore, light emitted into the light guide plate 200 can be uniformly directed in an upward direction regardless of the distance from the first light sources 300 and the second light sources 400.

Light output from the light guide plate 200 passes through the liquid crystal panel 800 so that images can be displayed on the liquid crystal panel 800.

Therefore, according to the current embodiments, the liquid crystal display has improved brightness uniformity. Particularly, although the liquid crystal display is large, the brightness of the liquid crystal display can be uniformly maintained.

Furthermore, according to the current embodiments, the liquid crystal display can have a large screen by using a light guide plate. Thus, the thickness of the liquid crystal display can be small although the screen of the liquid crystal display is large.

In addition, according to the current embodiments, since the liquid crystal display can have a large screen by using a light guide plate, images can be displayed on the liquid crystal display by using fewer LEDs. Therefore, the liquid crystal display of the current embodiments can be operated with less power.

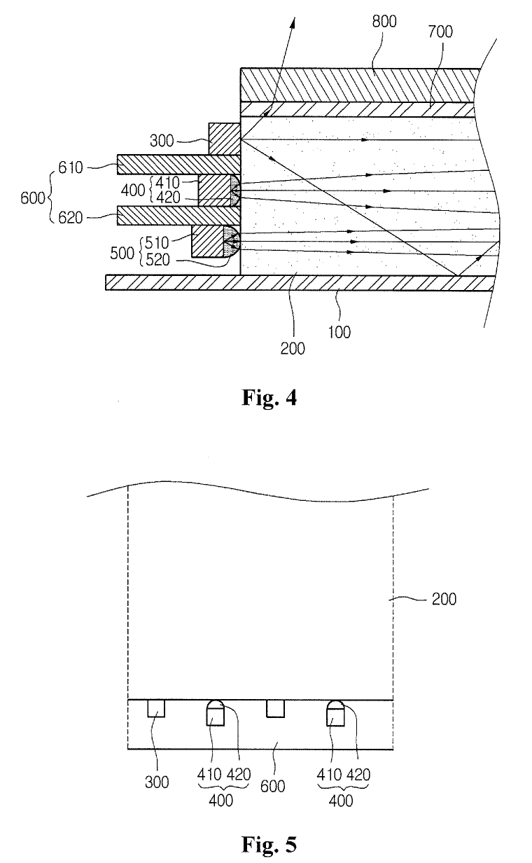

FIG. 4 is a cross-sectional view illustrating a liquid crystal display according to another embodiment. In the following description of the current embodiment, second light sources, third light sources, and a light emitting source substrate will be mainly explained with reference to the descriptions of the previous embodiments.

Referring to FIG. 4, the liquid crystal display includes a reflective plate 100, a light guide plate 200, first light sources 300, second light sources 400, third light sources 500, a light emitting source substrate 600, an optical sheet 700, and a liquid crystal panel 800.

Each of the second light sources 400 includes a first light emitting unit 410 and a first lens 420. The first light emitting unit 410 and the first lens 420 are the same as those of the previous embodiments.

The third light sources 500 are disposed at a side of the light guide plate 200. The third light sources 500 are disposed under the second light sources 400. The third light sources 500 may be arranged in a row.

Alternatively, the third light sources 500 may be disposed between the first light sources 300 and the second light sources 400.

Alternatively, the first light sources 300 may be disposed between the second light sources 400 and the third light sources 500.

The third light sources 500 emit light toward the light guide plate 200 and have a half-power angle smaller than that of the second light sources 400. That is, the third light sources 500 emit light diffused less than that emitted from the second light sources 400. Therefore, the third light sources 500 emit light that is more intensive and goes farther than light emitted by the second light sources 400.

Each of the third light sources 500 includes a second light emitting unit 510 and a second lens 520.

The second light emitting unit 510 emits light toward the second lens 520. The second light emitting unit 510 emits light toward the light guide plate 200. The second light emitting unit 510 is the same as the light emitting unit illustrated in the previous embodiments.

The second lens 520 is disposed on a second light emitting surface of the second light emitting unit 510. The second lens 520 is disposed between the second light emitting unit 510 and the light guide plate 200.

The second lens 520 diffuses light emitted from the second light emitting unit 510 with a diffusing degree smaller than that of the first lens 420. For example, light emitted from the second light emitting unit 510 and passing through the second lens 520 may be more parallel with the light guide plate 200 than light emitted from the first light emitting unit 410 and passing through the first lens 420.

For example, the thickness of the second lens 520 may be greater than the thickness of the first lens 420. The radius of curvature of the second lens 520 is smaller than the radius of curvature of the second lens 420. The second lens 520 is more convex than the first lens 420.

The light emitting source substrate 600 includes a first light emitting source substrate 610 and a second light emitting source substrate 620.

The first light emitting source substrate 610 is disposed between the first light sources 300 and the second light sources 400 and is electrically connected to the first light sources 300 and the second light sources 400.

The second light emitting source substrate 620 is disposed between the second light sources 400 and the third light sources 500 and is electrically connected to the third light sources 500 for driving the third light sources 500.

The liquid crystal display of the current embodiment includes the third light sources 500 configured to emit light that is condensed more than light emitted from the second light sources 400 and travels a longer distance than light emitted from the second light sources 400. Therefore, according to the current embodiment, the liquid crystal display can emit light more uniformly, and thus the liquid crystal display can have improved bright uniformity.

FIG. 5 is a plan view illustrating a light guide plate, first light sources, second light sources, and a light emitting source substrate according to an embodiment. In the following description of the current embodiment, arrangement of first and second light sources will be mainly explained with reference to the descriptions of the previous embodiments.

Referring to FIG. 5, a plurality of first light sources 300 and a plurality of second light sources 400 are alternately arranged in a row. The first light sources 300 and the second light sources 400 may be alternately arranged one by one.

Alternatively, a first light source 300 and two second light sources 400 may be repeatedly arranged.

Alternatively, a first light source 300 and three second light sources 400 may be repeatedly arranged.

Alternatively, the first light sources 300, the second light sources 400, and third light sources may be alternately arranged in a row. The first light sources 300, the second light sources 400, and the third light sources may be alternately arranged one by one.

Alternatively, a first light source 300, two second light sources 400, and three third light sources may be repeatedly arranged.

The first light sources 300, the second light sources 400, and the third light sources can be arranged in a row in various manners.

According to the current embodiment, the first light sources 300 and the second light sources 400 are arranged in a row in a liquid crystal display. Therefore, while maintaining the brightness uniformity of the liquid crystal display at a good level, the liquid crystal display can be made slimmer than the liquid crystal displays of the previous embodiments.

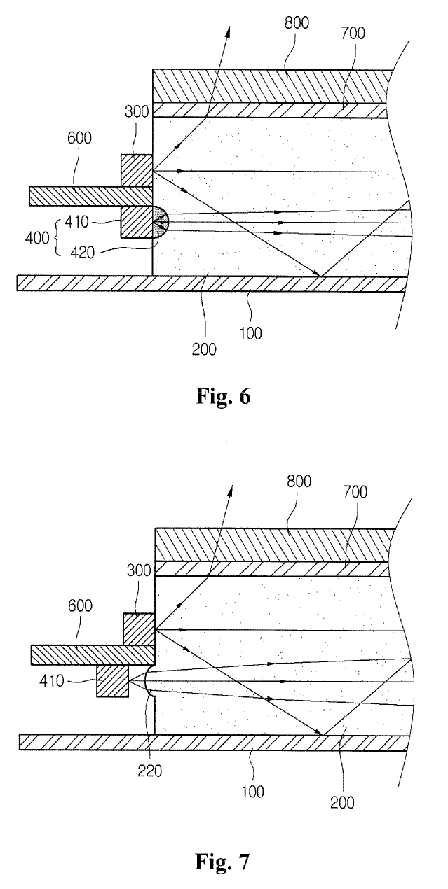

FIG. 6 is a cross-sectional view illustrating a liquid crystal display according to another embodiment. In the following description of the current embodiment, a light guide plate and a lens will be mainly explained with reference to the descriptions of the previous embodiments.

Referring to FIG. 6, a groove corresponding to a second light source 400 is formed in a light guide plate 200.

The second light source 400 is disposed at a position corresponding to the groove, and a lens 420 is disposed in the groove. The lens 420 has a refractive index higher than that of the light guide plate 200. The lens 420 is disposed inside the light guide plate 200.

The lens 420 may be in close contact with the light guide plate 200.

In the current embodiment, since the lens 420 is disposed in the groove, a light emitting unit 410 can be located closer to the light guide plate 200, and thus light loss can be reduced.

Therefore, the liquid crystal display of the current embodiment can have more improved brightness uniformity than the liquid crystal displays of the previous embodiments.

FIG. 7 is a cross-sectional view illustrating a liquid crystal display according to another embodiment. In the following description of the current embodiment, a light guide plate and a lens will be mainly explained with reference to the descriptions of the previous embodiments.

Referring to FIG. 7, a protrusion 220 corresponding to a second light source 400 is formed on a side of a light guide plate 200. The protrusion 220 is a convex protrusion having a predetermined radius of curvature. The light guide plate 200 and the protrusion 220 may be formed in one piece.

The second light source 400 is aligned with the protrusion 220. For example, the second light source 400 may be spaced a predetermined distance from the protrusion 220.

Light emitted from the second light source 400 is condensed by the protrusion 220. That is, the protrusion 220 has the same function as a lens. In other words, the protrusion 220 is substantially the same as the lens described above.

Light emitted from the second light source 400 is condensed by the protrusion 220 and thus less diffusive than light emitted from a first light source 300. Therefore, light emitted from the second light source 400 can travel a relatively long distance from a side at which the first and second light sources 300 and 400 are disposed.

Therefore, the liquid crystal display of the current embodiment can have improved brightness uniformity.

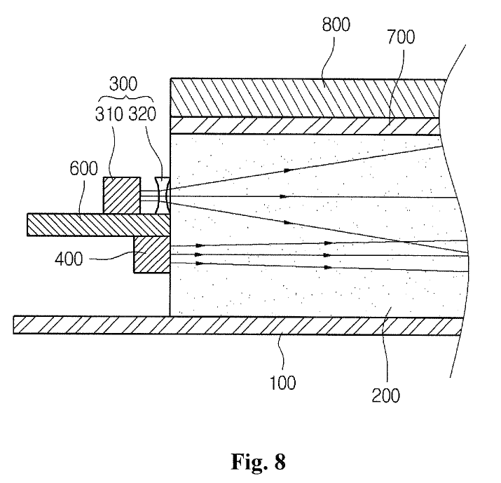

FIG. 8 is a cross-sectional view illustrating a liquid crystal display according to another embodiment. In the following description of the current embodiment, first and second light sources will be mainly explained with reference to the descriptions of the previous embodiments.

Referring to FIG. 8, the liquid crystal display includes first and second light sources 300 and 400.

The first light source 300 includes a laser generating unit 310 and a half-power angle adjusting member 320. For example, the laser generating unit 310 may be a light source including a laser diode and capable of emitting laser light.

The half-power angle adjusting member 320 is disposed at the laser generating unit 310. The half-power angle adjusting member 320 diffuses light emitted from the laser generating unit 310. For example, the half-power angle adjusting member 320 may be a concave lens. The half-power angle adjusting member 320 increases the half-power angle of laser light emitted from the laser generating unit 310.

The second light source 400 has a half-power angle smaller than that of the first light source 300. Therefore, light emitted from the second light source 400 travels a longer distance than light emitted from the first light source 300. For example, the second light source 400 may be a light source including a laser diode and capable of emitting laser light.

Light emitted from the first light source 300 is more diffusive than light emitted from the second light source 400. Therefore, light emitted from the first light source 300 travels a relatively short distance from the first light source 300 and the second light source 400.

On the other hand, light emitted from the second light source 400 is less diffusive than light emitted from the first light source 300. Therefore, light emitted from the second light source 400 travels a relatively longer distance from the first light source 300 and the second light source 400.

Therefore, light emitted into the light guide plate 200 can be uniformly directed in an upward direction regardless of the distance from the first light sources 300 and the second light sources 400.

Thus, the liquid crystal display of the current embodiment can have improved brightness and brightness uniformity.

Any reference in this specification to “one embodiment,” “an embodiment,” “example embodiment,” etc., means that a particular feature, structure, or characteristic described in connection with the embodiment is included in at least one embodiment of the invention. The appearances of such phrases in various places in the specification are not necessarily all referring to the same embodiment. Further, when a particular feature, structure, or characteristic is described in connection with any embodiment, it is submitted that it is within the purview of one skilled in the art to effect such feature, structure, or characteristic in connection with other ones of the embodiments.

Although embodiments have been described with reference to a number of illustrative embodiments thereof, it should be understood that numerous other modifications and embodiments can be devised by those skilled in the art that will fall within the spirit and scope of the principles of this disclosure. More particularly, various variations and modifications are possible in the component parts and/or arrangements of the subject combination arrangement within the scope of the disclosure, the drawings and the appended claims. In addition to variations and modifications in the component parts and/or arrangements, alternative uses will also be apparent to those skilled in the art.

What is claimed is:

1. A display device comprising:
a light guide plate;
a first light source being disposed at a side of the light guide plate and having a first half-power angle;
a second light source being disposed at the side of the light guide plate and having a second half-power angle; and
a display panel on the light guide plate.

2. The display device according to claim 1, further comprising a driving substrate between the first and second light sources.

3. The display device according to claim 1, wherein the second light source comprises:
a light emitting unit configured to generate light; and
a lens disposed between the light emitting unit and the light guide plate.

4. The display device according to claim 1, further comprising a third light source being disposed at the side of the light guide plate and having a third half-power angle.

5. The display device according to claim 4, wherein the second light source comprises a light emitting unit and a first lens disposed at the light emitting unit for condensing light emitted from the light emitting unit, and
the third light source comprises a second lens that is more convex than the first lens.

6. The display device according to claim 1, wherein the second light source emits laser light.

7. A display device comprising:
a light guide plate;
first and second light sources at a side of the light guide plate;
a half-power angle adjustment member between the light guide plate and the first light source; and
a display panel on the light guide plate.

8. The display device according to claim 7, wherein the half-power angle adjustment member condenses light emitted from the first light source.

9. The display device according to claim 7, wherein the half-power angle adjustment member comprises a concave lens.

10. The display device according to claim 7, wherein the half-power angle adjustment member and the light guide plate are formed in one piece.

11. The display device according to claim 7, wherein the half-power angle adjustment member has a refractive index greater than that of the light guide plate.

12. The display device according to claim 7, wherein the half-power angle adjustment member is a concave groove formed in the side of the light guide plate at a position corresponding to the first light source.

13. The display device according to claim 7, wherein the half-power angle adjustment member is a convex protrusion disposed on the side of the light guide plate at a position corresponding to the first light source.

14. The display device according to claim 7, wherein the half-power angle adjustment member is disposed in the light guide plate.

15. A display device comprising:
a light guide plate;
a plurality of first light sources at a side of the light guide plate;
a plurality of second light sources disposed at the side of the light guide plate and having an angular light distribution distinguished from that of the first light source; and
a display panel on the light guide plate.

16. The display device according to claim 15, wherein the first and second light sources are alternately arranged.

17. The display device according to claim 15, wherein the first light sources are arranged in a row, and the second light sources are arranged on the first light sources in a row, and
wherein the display device further comprises a substrate disposed between the first light sources and the second light sources and electrically connected to the first light sources and the second light sources.

18. The display device of claim 17, wherein the substrate is a metal printed circuit board.

19. The display device of claim 17, further comprising:
a plurality of third light sources having an angular light distribution distinguished from those of the first light source and the second light source, and arranged in a row; and
a substrate between the third light sources and the second light sources.

20. The display device according to claim 15, wherein the second light sources have output power greater than that of the first light sources.
